(19) United States
(12) Patent Application Publication
(10) Pub. No.: US 2006/0192846 A1
(43) Pub. Date: Aug. 31, 2006

(54) Menu generator device and menu generating method for complementing video/audio signals with menu information

(75) Inventor: Thomas Gruber, Gols (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., BA Eindhoven (NL)

(21) Appl. No.: 10/553,917

(22) PCT Filed: Apr. 21, 2004
(86) PCT No.: PCT/IB04/50472

§ 371 Date: Oct. 20, 2005

(30) Foreign Application Priority Data
Apr. 24, 2003 (EP) 03101134.9

(51) Int. Cl. H04N 7/14

(52) U.S. Cl. 348/14.01

(57) ABSTRACT

In a menu generator device (1) for complementing video/audio signals (VA) with menu information (MI), which audio/video signals (VA) may possibly be divided into a plurality of sequences, there are provided a read-in stage (2) for reading in the video/audio signals (VA), an analyzing stage (3) for generating video/audio identifying information (VAID) from the video/audio signals (VA) read in, a communications stage (4) for transmitting the video/audio identifying information (VA-ID) to a remote menu data server (20) and for receiving, from the menu data server, menu data (MD) assignable to the video/audio identifying information (VA-ID) transmitted, and a menu generator stage (5) for generating menu information (MI) from the menu data (MD) and for emitting the menu information 10 (MI) for connection with the video/audio signals (VA).

The invention relates to a menu generator device for complementing video/audio signals with menu information, which video/audio signals may possibly be divided into a plurality of sequences.

The invention further relates to a menu generating method for complementing video/audio signals with menu information, which video/audio signals may possibly be divided into a plurality of sequences.

The invention further relates to a method of operating a menu data server for supplying menu data when requested by a menu generator device.

The invention further relates to a device for processing a video/audio signal, which device contains a menu generator device as described in the first paragraph above.

When a DVD is produced with a DVD recorder, it is known for there automatically to be created a menu that, to represent each video film recorded on the DVD, has as part of the menu a single picture and possibly also the time and the channel or other information, such as the title if this is included in the recording signal.

However, apart from the information mentioned, the menu does not contain any information that makes it easier for the user to make use of the DVD produced in this way and that might provide him with what is termed metadata, such as details of the content of the video film recorded, on the artists appearing in it, and so on. What is particularly disadvantageous is that, with the menu that is created in this way, individual sequences of a video film that has been recorded on the DVD with the DVD recorder cannot be accessed directly via the menu. Rather, the user has to search manually for the sequences of interest to him.

In patent document EP 1 154 433, there is proposed, for radio and television broadcasts recorded by means of a video recorder or the like—referred to in general terms as a recording and/or reproducing device—what is termed an “index on demand” service in which a professional supplier (e.g. the radio station making the broadcasts) offers indexes for the broadcasts, provided with time stamps, for downloading over the internet. To use this service, the user has to log on with the supplier over the internet, with the help of a computer, and can then make a manual search through the indexes offered to find the one he wants. Having found it, he can download it to his computer. To enable the downloaded index actually to be used to allow particular passages in the broadcast that has been recorded to be selected, there has to be a connection between the computer on which the index is stored and the recording and/or reproducing device. Because the interfaces between a computer and a recording and/or reproducing device are not sufficiently standardized, and also because the user is not normally prepared to connect his recording and/or reproducing device to a computer simply to play back recorded broadcasts, the proposed solution is confined in practice to those cases in which the computer is, at the same time, the recording and/or reproducing device.

It is an object of the invention to provide a menu generator device of the kind specified in the first paragraph above, a menu generating method of the kind specified in the second paragraph above, a method of operating a menu data server of the kind specified in the third paragraph above and a device of the kind specified in the fourth paragraph above, in which the disadvantages specified above are avoided.

To allow the above object to be achieved, provisions according to the invention are made in a menu generator device such that said menu generator device according to the invention can be characterized in the manner specified below, namely:

A menu generator device for complementing video/audio signals with menu information, which video/audio signals may possibly be divided into a plurality of sequences, comprising read-in means for reading in the video/audio signals, analyzing means for generating video/audio identifying information from the video/audio signals read in, communications means for transmitting the video/audio identifying information to a remote menu data server and for receiving, from the menu data server, menu data assignable to the video/audio identifying information transmitted, and menu generator means for generating menu information from the menu data and for delivering the menu information to be connected with the video/audio signals.

To enable the above object to be achieved, there are provided in a menu generating method according to the invention features according to the invention such that a menu generating method according to the invention can be characterized in the manner specified below, namely:

A menu generating method for complementing video/audio signals with menu information, which video/audio signals may possibly be divided into a plurality of sequences, comprising reading in the video/audio signals, analyzing the video/audio signals and generating video/audio identifying information from the video/audio signals read in, transmitting the video/audio identifying information to a remote menu data server and receiving, from the menu data server, menu data assignable to the video/audio identifying information transmitted, generating menu information from the menu data and delivering the menu information to be connected with the video/audio signals.

To enable the above object to be achieved, there are provided in a method according to the invention of operating a menu data server features according to the invention such that a method according to the invention of operating a menu data server can be characterized in the manner specified below, namely:

A method of operating a menu data server for supplying menu data when requested by a menu generator device, comprising receiving a request from the menu generator device that contains video/audio identifying information, the video/audio identifying information having been generated by the menu generator device by analyzing video/audio signals read in at the menu generator device, determining, from a menu database that communicates with the menu data server and contains menu data and video/audio identifying information connected therewith, a menu data entry corresponding to the video/audio identifying information received, the determination being performed by comparing the video/audio identifying information received with the video/audio identifying information stored in the database, and transmitting the menu data determined to the menu generator device making the request.

To enable the above object to be achieved, a device according to the invention is provided with a menu generator device according to the invention.

What is achieved by the provision of the features according to the invention is that a user is able to provide video/audio signals, of the kind that are for example recorded on a DVD that he has recorded himself, with menu information that makes it possible for him to navigate to individual sequences in the video/audio signals without a tedious search for the given sequence being required for this purpose. The menu information may also comprise background knowledge, comparable to what is offered on commercial DVD's. What is more, it is ensured that the menu information can be connected with the video/audio signals, i.e. can be embedded therein, so that there is no need either for special recording and/or playback devices or for a combination of a computer and a device of this kind as there is in the prior art. An essential advantage of the solution according to the invention also lies in that fact that the video/audio signal identifying information is extracted from the video/audio signals automatically, thus sparing the user the tedious job of searching through extensive index lists manually in the way that is usual in the prior art.

Under the provisions made in claims 2 and 11, the advantage is obtained that sequence-specific metadata can be displayed via the menu.

Under the provisions made in claims 3 and 12, the advantage is obtained that individual sequences can be homed in on exactly in respect of time via the menu.

Under the provisions made in claims 4 and 13, it is possible for navigation between individual sequences to take place conveniently via the menu, with allowance being made for the length of sections extraneous to the content of interest, e.g. commercials, to enable the entry points to the individual sequences to be determined correctly.

Under the provisions made in claims 5, 14 and 20, the advantage is obtained that characteristic textual information, such as is present for example in a leader or a trailer of a film, can be extracted from a video component of the video/audio signals with relatively low susceptibility to errors and at a relatively high processing speed, in which case the use of so-called text pattern recognition means has proved particularly advantageous. Use may also be made of speech recognition means to extract textual information, which is for example present in the form of spoken language during a film, from an audio component of the video/audio signals.

In a further advantageous embodiment of the invention that is detailed in claims 6, 15 and 21, there is extracted from the video/audio signals characteristic audio information that can be represented in the form of sonograms or plots of frequency or plots against time, in which case, particularly when representation is in the form of a plot of frequency, a substantial reduction is obtained in the volumes of data required, thus enabling the video/audio identifying information to be subjected to further processing relatively quickly.

As an alternative to this, under claims 7, 16 and 22 video information can be extracted from the video/audio signals as video/audio identifying information, which gives the advantage that a film for example that is represented by the video/audio signals can be identified relatively accurately.

Under the provisions of claims 8, 17 and 23, use can be made, advantageously and with virtually no errors, of metadata such as the time of transmission, the broadcaster, etc. which is often transmitted directly along with the video/audio signals, as in the case of a cable television system for example or in the form of teletext.

Under the provisions of claim 9, the advantage is obtained that, even when there are a plurality of sets of menu data corresponding to the video/audio signals analyzed, a user can intervene manually to select menu data that he personally prefers.

Under the provisions of claim 24, the advantage is obtained that the supply of menu data may be confined to a defined group of users. In this way, the menu data that is made available can be supplied for a charge, for example by payment by means of credit card or by a subscription system, which in turn increases the interest that media companies, such as radio stations for example, have in making available menu data for the broadcasts made by them, such as for example feature films or documentaries. The large amount of menu data that is made available as a result will in turn increase the acceptance of the system among users.

The advantages listed above in connection with the menu generator device according to the invention are also obtained with a device according to the invention.

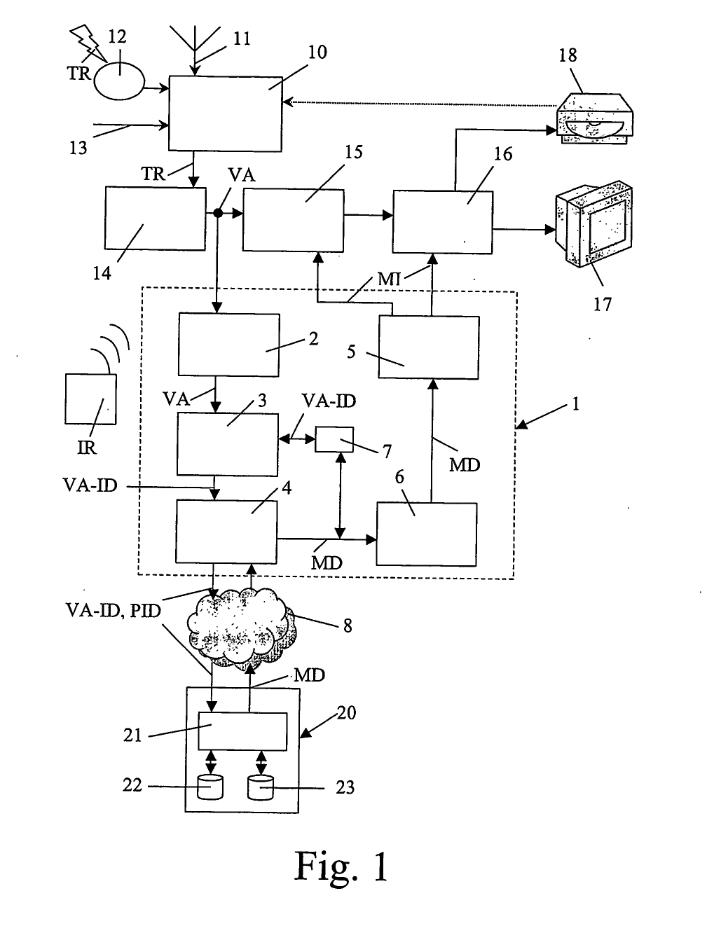

These and other aspects of the invention are apparent from and will be elucidated with reference to the embodiment shown in FIG. 1 and described hereinafter, although the invention is not limited to this embodiment.

In the drawings:

FIG. 1 is a block circuit diagram of a menu generator device according to the invention that is incorporated in a DVD recorder device.

FIG. 1 shows a DVD recorder device that has receiving means 10 that are able to receive transmission signals TR, in which video/audio signals VA are encoded, via a terrestrial antenna 11, a satellite receiving antenna 12 or a cable 13. Also provided is video/audio input decoder 14 for decoding the video/audio signals VA from the transmission signals TR. The video/audio signals VA are fed to a video/audio encoder 15, in which they are converted to a desired format, such as MPEG for example, and are then prepared in a video/audio output processing unit 16 for display on a monitor 17 and/or for storage in a video/audio storage means 18. As described up to this point, the items in question may also form parts of a set-top box or a video recording unit, such as a DVD-RW recorder, a hard-disk recorder or a recorder having a semiconductor memory. Hence the video/audio storage means 18 may have optical, magnetic, magneto-optical or semiconductor memories. Also, the DVD recorder device may be in the form of a combination recorder that has both a hard-disk and a writable DVD as storage means, thus enabling menu information to be added when a film is being copied from the hard-disk to the DVD. A combination recorder of this kind may for example take the form of a PC having a built-in hard disk, a DVD-RW station and a network connection.

From the output of the video/audio input decoder 14, the video/audio signals VA are also fed to a menu generator device 1 according to the invention, that is to say to video/audio read-in means 2 and from there to analyzing means 3 of the menu generator device 1. Video/audio identifying information VA-ID is generated in the analyzing means 3 from the video/audio signals VA read in and is buffer-stored in the storage means 7 as a link to be used later and/or is passed on to communications means 4. The video/audio identifying information VA-ID may be generated in the analyzing means 3 in a number of different ways. Text contained in the images of the video signals may for example be filtered out of the video signals forming part of the video/audio signals VA and this text may be used as video/audio identifying information VA-ID. In a more technically complicated embodiment, speech recognition means may be used to recognize spoken words contained in the audio signals forming part of the video/audio signals VA and to transcribe them into text that is used as video/audio identifying information VA-ID. In a further embodiment of the analyzing means 3, characteristic video or audio signals from the video/audio signals VA themselves are used as video/audio identifying information VA-ID by, in the case of the video signals for example, representing the waveform of the luminance signal (Y) over time as a graph. This graph can form the video/audio identifying information VA-ID, in which case recourse is had to single pictures or a plurality of connected pictures. A similar approach may also be adopted with the characteristic waveform of the audio signal, which can be represented either as a plot against time or a plot of frequency or a sonogram, in which case this representation can be used as video/audio identifying information VA-ID. In a further embodiment according to the invention of the analyzing means 3, metadata that was transmitted together with the video/audio signals is analyzed. This metadata may be contained as a so-called header in a stream of video/audio signals or data stream that is received via for example the satellite antenna 12 or the cable link 13. What are generally encoded in this header are items of information such as the title of the broadcast transmitted, the time of transmission, the date of transmission, the radio station making the broadcast, etc., which items of information are extracted by the analyzing means 3 and supplied as video/audio identifying information VA-ID.

The video/audio identifying information VA-ID that is generated by the analyzing means 3 by the method described above is transmitted via the communications means 4 over a remote data link 8, which may be the internet, to a remote menu data server 20. This menu data server 20 comprises comparator means 21, a menu data database 22 and a subscriber database 23. The comparator means 21 are provided to enable a suitable menu data entry MD to be selected from the menu data database 22, which latter contains a large number of data sets comprising menu data and video/audio identifying information correlated therewith, the comparator means 21 making the selection by comparing the video/audio identifying information VA-ID received with the video/audio identifying information stored in the menu data database 22, in which case the video/audio identifying information may comprise textual information extracted from video/audio signals, characteristic audio information, characteristic video information comprising single pictures or a plurality of successive pictures, or coded broadcaster codes, or time of transmission and date of transmission, etc. As an option, the menu data server 20 may be so configured that access to menu data in the menu data database 22 is permitted or embargoed by reference to user identifiers PID or lists of subscribers that are stored in the subscriber database 23. The menu data held in store is generally made available by commercial suppliers, such as media companies or radio stations.

The menu data MD that is determined by the menu data server 20 on receipt of specific video/audio identifying information VA-ID and, where required, after checking an associated user identifier PID, is transmitted to the communications means 4 of the menu generator device 1 that made the request and is passed on by the communications means 4 to menu selecting means 6. This is because the menu data MD may in fact contain information that allows a plurality of different menus suited to the video/audio signals VA to be created, in which case the user can carry out a pre-selection by means of the menu selecting means 6. The menu data MD selected is fed to menu generator means 5 by means of which menu information MI is created by reference to the menu data MD and is set to a format that is compatible with the video/audio encoder 15 and the video/audio output processing unit 16. The menu information MI generated is passed by the menu generator means 5 to the video/audio encoder 15, where the video/audio signals VA are correlated with the menu information MI. Where required, the menu generator means 5 also calculate the correlations of individual sequences in the video/audio signals VA with the corresponding start times or entry points, in which case allowance is also made for the length of sections extraneous to the content of interest, which sections are generally ignored in the menu data MD. The menu information MI created is then recorded in this form on the DVD together with the video/audio signals VA. The menu information MI created can be shown on the monitor 17 as an on-screen display (OSD). By means of a remote control IR, it is possible both to navigate in the menu and to control the menu generator device 1 according to the invention. The entire DVD recorder device in which the menu generator device 1 is incorporated may also be controlled with the remote control device IR.

In relation to a DVD recorder device having a menu generator device 1 incorporated therein, a typical operating procedure looks like this to the user:

The user starts recording a film or some other broadcast.

While the recording is still talking place, the analysis of the video/audio signals VA received is already underway, the first five to ten minutes of the film or broadcast preferably being examined for one of the technical criteria explained above (text contained, etc.), which is used as video/audio identifying information VA-ID.

As an alternative to this, provision may be made for the user to have to actively start the analysis, for example by selecting an appropriate menu option in an OSD.

The analysis having been made, the video/audio identifying information VA-ID determined is buffer-stored for use later on, or is immediately transmitted to the menu data server 20 and it is the menu data MD that is then received that is buffer-stored.

The recording having been completed, the user is asked, via the OSD, to decide whether a menu is now to be created for the broadcast. If he says “Yes”, the video/audio identifying information VA-ID is then transmitted to the menu data server 20 and the reception of the menu data MD is awaited or, if the menu data MD had already been received during the recording process, the buffer-stored menu data MD is used to create the menu. The menu that can be created in this way may, like the menus of commercially available DVD's, contain information on the actors, the content of the film, its individual sequences, entry points to the individual sequences, etc. The menu generator means also enable the user to arrange the menu to have graphic appeal, for example by selecting what are called “skins”, i.e. predefined graphic inserts or covers for the viewed area.

1. A menu generator device (1) for complementing video/audio signals (VA) with menu information (MI), which video/audio signals (VA) may possibly be divided into a plurality of sequences, comprising:
read-in means (2) for reading in the video/audio signals (VA),
analyzing means (3) for generating video/audio identifying information (VA-ID) from the video/audio signals (VA) read in,
communications means (4) for transmitting the video/audio identifying information (VA-ID) to a remote menu data server (20) and for receiving, from the menu data server, menu data (MD) assignable to the video/audio identifying information transmitted (VA-ID), and
menu generator means (5) for generating menu information (MI) from the menu data (MD) and for emitting the menu information (MI) for connection with the video/audio signals (VA).

2. A menu generator device as claimed in claim 1, characterized in that the menu generator means (5) are arranged to generate parts of the menu information (MI), which parts of the menu information (MI) are assigned to respective sequences in the video/audio signals (VA), and
in that the menu generator means (5) are arranged to emit the parts of the menu information (MI) for connection with the sequences in the video/audio signals (VA).

3. A menu generator device as claimed in claim 2, characterized in that the menu generator means (5) are arranged to generate parts of the menu information, which parts of the menu information contain time information on the relative or absolute starting times of the sequences within the video/audio signals (VA).

4. A menu generator device as claimed in claim 3, characterized in that the menu generator means (5) are arranged to re-calculate the time information as a function of sections extraneous to the content of interest that are contained in the video/audio signals (VA), e.g. commercials.

5. A menu generator device as claimed in claim 1, characterized in that the analyzing means (3) are arranged to extract textual information from the video/audio signals (VA) read in, as the video/audio identifying information (VA-ID).

6. A menu generator device as claimed in claim 1, characterized in that the analyzing means (3) are arranged to extract audio information from the video/audio signals (VA) read in, as the video/audio identifying information (VA-ID).

7. A menu generator device as claimed in claim 1, characterized in that the analyzing means (3) are arranged to extract video information comprising a single picture or a plurality of successive pictures from the video/audio signals (VA) read in, as the video/audio identifying information (VA-ID).

8. A menu generator device as claimed in claim 1, characterized in that the analyzing means (3) are arranged to extract textual information comprising a broadcaster code and/or a time of transmission and/or a date of transmission, etc. from metadata connected with the video/audio signals (VA) read in, as the video/audio identifying information (VA-ID).

9. A menu generator device as claimed in claim 1, characterized in that the menu generator means (5) have connected upstream of them menu data selecting means (6) that are arranged to allow the user-controlled selection of menu data (MD), from a plurality of sets of such data, for the generation of the menu information (MI).

10. A menu generating method for complementing video/audio signals (VA) with menu information (MI), which video/audio signals (VA) may possibly be divided into a plurality of sequences, comprising:
reading in the video/audio signals (VA),
analyzing the video/audio signals (VA) and generating video/audio identifying information (VA-ID) from the video/audio signals (VA) read in,
transmitting the video/audio identifying information (VA-ID) to a remote menu data server (20) and receiving, from the menu data server (20), menu data (MD) assignable to the video/audio identifying information (VA-ID) transmitted,
generating menu information (MI) from the menu data (MD) and emitting the menu information (MI) for connection with the video/audio signals (VA).

11. A menu generating method as claimed in claim 10, characterized in that parts of the menu information (MI) are generated, which parts of the menu information are assigned to respective sequences in the video/audio signals (VA), and in that the parts of the menu information (MI) are emitted for connection with the sequences in the video/audio signals (VA).

12. A menu generating method as claimed in claim 11, characterized in that parts of the menu information are generated, which parts of the menu information contain time information on the relative or absolute starting times of the sequences within the video/audio signals (VA).

13. A menu generating method as claimed in claim 12, characterized in that the time information is re-calculated as a function of sections extraneous to the content of interest that are contained in the video/audio signals, e.g. commercials.

14. A menu generating method as claimed in claim 10, characterized in that the video/audio identifying information (VA-ID) is generated by extracting textual information from the video/audio signals (VA) read in.

15. A menu generating method as claimed in claim 10, characterized in that the video/audio identifying information (VA-ID) is generated by extracting audio information from the video/audio signals (VA) read in.

16. A menu generating method as claimed in claim 10, characterized in that the video/audio identifying information (VA-ID) is generated by extracting video information comprising a single picture or a plurality of successive pictures from the video/audio signals (VA) read in.

17. A menu generating method as claimed in claim 10, characterized in that the video/audio identifying information (VA-ID) is generated by extracting textual information comprising a broadcaster code and/or a time of transmission and/or a date of transmission, etc. from metadata connected with the video/audio signals (VA) read in.

18. A menu generating method as claimed in claim 10, characterized in that menu data (MD) that is determined for the generation of the menu information (MI) is selected from a plurality of sets of such menu data (MD) under user control with the help of menu data selecting means (6) connected upstream of the menu generator means (5).

19. A method of operating a menu data server (20) for supplying menu data (MD) when requested by a menu generator device (1), comprising:
receiving from the menu generator device (1) a request that contains video/audio identifying information (VA-ID), the video/audio identifying information (VA-ID) having been generated by the menu generator device (1) by analyzing video/audio signals (VA) read in at the menu generator device (1),
determining, from a menu data database that communicates with the menu data server and contains menu data (MD) and video/audio identifying information connected therewith, a menu data entry corresponding to the video/audio identifying information (VA-ID) received, the determination being performed by comparing the video/audio identifying information (VA-ID) received with the video/audio identifying information stored in the database, and
transmitting the menu data (MD) determined to the menu generator device (1) making the request.

20. A method as claimed in claim 19, characterized in that the determination of the menu data (MD) comprises comparing textual information forming the received video/audio identifying information (VA-ID), which textual information was extracted from the video/audio signals (VA) at the menu generator device (1), with textual information that is stored on the database and forms the stored video/audio identifying information.

21. A method as claimed in claim 19, characterized in that the determination of the menu data (MD) comprises comparing audio information forming the received video/audio identifying information (VA-ID), which audio information was extracted from the video/audio signals (VA) at the menu generator device (1), with audio information that is stored on the database and forms the stored video/audio identifying information.

22. A method as claimed in claim 19, characterized in that the determination of the menu data (MD) comprises comparing video information that comprises a single picture or a plurality of successive pictures and that forms the received video/audio identifying information (VA-ID), which video information was extracted from the video/audio signals (VA) at the menu generator device (1), with video information that is stored on the database and forms the stored video/audio identifying information.

23. A method as claimed in claim 19, characterized in that the determination of the menu data (MD) comprises comparing textual information that contains a broadcaster code and/or a time of transmission and/or a date of transmission, etc. and that forms the received video/audio identifying information (VA-ID), which textual information was extracted at the menu generator device (1) from metadata supplementing a video/audio signal (VA) read in with the help of the menu generator device (1), with textual information that is stored on the database and forms the stored video/audio identifying information.

24. A method as claimed in claim 19, characterized in that the determination and emission of menu data (MD) to the menu generator device (1) is controlled by reference to user identifiers (PID's) that are received as part of the request from the menu generator device (1) and/or by reference to subscriber lists available from the menu data server.

25. A device that is arranged to process a video/audio signal (VA), having a menu generator device (1) as claimed in claim 1.
